(19) United States
(12) Patent Application Publication
(10) Pub. No.: US 2003/0136644 A1
(43) Pub. Date: Jul. 24, 2003

(54) Method and system for aspirating sample volumes from luggage/packages for test

(76) Inventor: Philip T. James, Bristow, VA (US)

Correspondence Address: WALLACE G. WALTER, 5726 CLARENCE AVE, ALEXANDRIA, VA, 22311-1008, US

(21) Appl. No.: 10/183,647

(22) Filed: Jun. 28, 2002

Related U.S. Application Data
(60) Provisional application No. 60/349,245, filed on Jan. 18, 2002.

(51) Int. Cl. B65G 13/02

(52) U.S. Cl. 198/780

(57) ABSTRACT

A method and system for aspirating sample volumes from luggage/packages for testing includes a series of rollers that convey each luggage article or package through a pressurized flow of air; the rollers are organized to subject each luggage article or package to a series of forces or kinetic movements to effect a momentary volumetric reduction and/or cause displacement of the contents to cause interior air to be expressed or aspirated. A sensor suite tests the aspirated air for the presence of proscribed materials, including those related to explosive, hazardous chemicals, and/or biohazards.

### BACKGROUND OF THE INVENTION

This application claims the benefit of U.S. Provisional Patent Application No. 60/349,245 filed Jan. 18, 2002 by the inventor herein.

The present invention relates to a method and system for aspirating sample air or gas volumes from luggage/packages for test purposes and, more particularly, to a system for subjecting luggage and/or package articles to regular or irregular movements to cause a volume of air from the interior space of the luggage and/or package to be expressed or aspirated therefrom.

In general, a need exists to subject each luggage article or package handled by airport, rail, and bus transport systems to some type of inspection for the presence of dangerous or otherwise proscribed materials, such as explosives, dangerous chemicals, and/or biohazards.

Various types of sensors have been developed to sense the presence of explosives and/or biohazards material particles or vapors suspended or entrained in air. While these types of sensors are effective for their intended design purpose, they are of limited value in detecting the presence of a hazardous substance in the interior volume of closed luggage articles and other packages, particularly when those luggage articles or packages are part of a continuously moving stream or flow of luggage articles or packages.

### SUMMARY OF THE INVENTION

In view of the above, it is an object of the present invention, among others, to provide a method and system for aspirating sample volumes from luggage/packages for testing purposes.

It is another object of the present invention to provide a method and system for aspirating sample volumes from luggage/packages for test that subjects the luggage/package to kinetic forces and/or kinetically induced movements having a high-probability of expressing a portion of the interior air volume therefrom.

It is still another object of the present invention to provide a method and system for aspirating sample volumes from luggage/packages for test using the “bellows” effect to express a portion of the interior air volume.

It is a further object of the present invention to provide a method and system for aspirating sample volumes from luggage/packages for test using the “piston” effect to express a portion of the interior air volume.

In view of these objects, and others, the present invention provides a method and system for aspirating sample volumes from luggage/packages for test in which each luggage article or package is transported along a series of rollers that are organized to subject the luggage article or package to forces designed to effect at least a momentary and partial compression or volumetric reduction to express a portion of the interior air therefrom or to cause the interior contents to shift or displace position to likewise to express a portion of the interior air therefrom.

In the preferred form of the invention, a series of rollers are provided to convey each luggage article or package through a pressurized flow of air; the rollers are organized to subject each luggage article or package to a series of forces or kinetic movements to effect the volumetric reduction thereof and/or the displacement of the contents therein to cause interior air to be expressed or aspirated. A sensor suite tests the aspirated air for the presence of proscribed materials, including those related to explosives, hazardous chemicals, and/or biohazards.

The present invention advantageously provides a method and system for aspirating sample volumes from luggage/packages for test assessment that can accommodate a continuous stream of luggage articles or packages in an efficient and economical manner.

Other objects and further scope of applicability of the present invention will become apparent from the detailed description to follow, taken in conjunction with the accompanying drawings, in which like parts are designated by like reference characters.

### BRIEF DESCRIPTION OF THE DRAWING

FIG. 1 is an elevational view of a one of a number of system organizations for aspirating sample volumes from luggage/packages for test in accordance with the present invention;

FIGS. 1a and 1b represent a variation of the relative alignment of the various rollers of FIG. 1;

FIG. 2 illustrates a first variation of the organization of FIG. 1;

FIG. 3 illustrates a second variation of the organization of FIG. 1;

FIG. 4 illustrates a third variation of the organization of FIG. 1;

FIG. 5 illustrates yet another variation of the organization of FIG. 1;

FIG. 6 illustrates yet another variation of the roller organization in accordance with the present invention; and

FIG. 7 illustrates, in schematic fashion, the manner by which the system of the present invention is utilized in conjunction with a X-ray or similar imaging device.

### DESCRIPTION OF THE PREFERRED EMBODIMENT

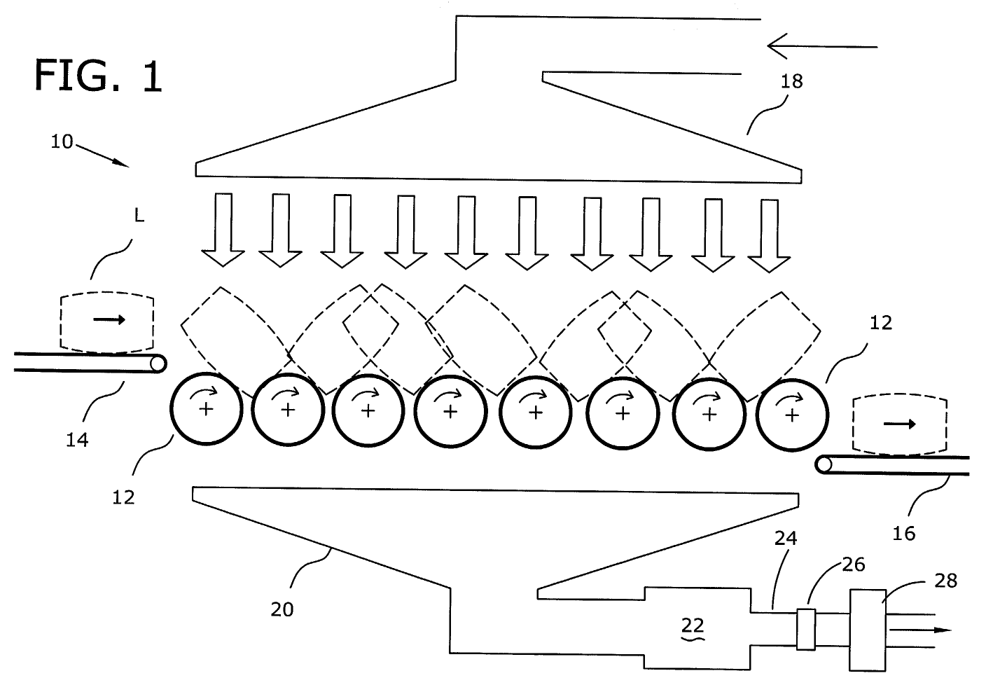

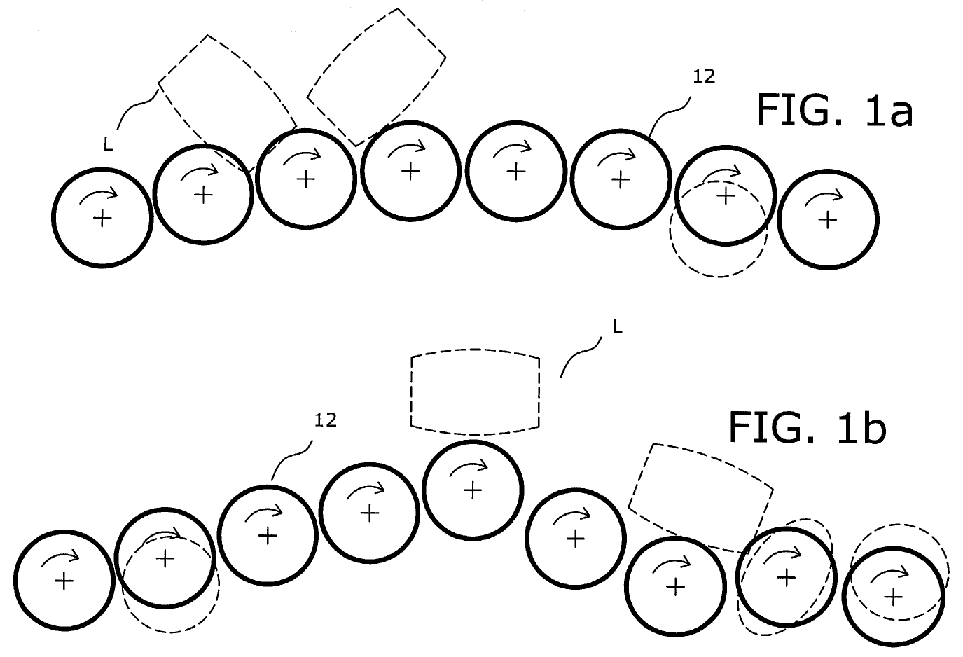

A representative system for aspirating sample volumes from luggage/packages for test purposes in accordance with the present invention is shown in FIG. 1 and designated generally therein by the reference character 10. As shown, the system 10 is defined by a set of transport rollers 12 extending between a first conveyor belt 14 that delivers successive luggage articles L (shown in dotted-line illustration) or packages onto the leftmost roller 12 and another conveyor belt 16 that conveys the luggage articles L or packages from the rightmost roller 12. In FIG. 1, the various rollers 12 are shown as equi-spaced and aligned along a common plane and of the same diameter. The rollers 12 may be driven by individual motors at the same or different speeds or may be driven in common using a cogged belt or chain drive.

The organization shown in FIG. 1 is merely representative of various other organizations. For example and as explained below, the rollers can be of different sizes and elevations relative one another, need not been driven, or, if driven, need not be driven at the same speed or direction, and need not be cylindrical.

As is known, travelers use a wide variety of luggage, cases, carriers, bags, etc. to carry their possessions while traveling. Examples of these articles include hard-sided suitcases, soft-sided suitcases, suit carriers, shoulder bags, attaches, backpacks, and a variety of wheeled carriers. In general, the majority (if not the overwhelming majority) of luggage is fabricated from woven nylon or other synthetic material to form a ‘soft-sided’ article. In those types of luggage having internal frame structures, such as wheeled carts, it is not uncommon for the exterior of the luggage to be also fabricated from a heavy-duty fabric to provide a shape-sustaining article with resiliently yieldable panels.

The present invention contemplates that both fabric-based “soft-sided” luggage and molded plastic “hard-sided” luggage have, in general, sufficient shape-sustaining characteristic to define an interior volume for the articles carried in the luggage and to define various air spaces between those articles and any unoccupied spaces in the luggage. The shape of soft-sided luggage can be changed by merely applying a force thereto; it is thus possible to forcibly change and momentarily reduce the interior volume of the luggage to express a portion of the interior air therefrom. Since soft-sided luggage uses zippers and Velcro-type hook and loop closure systems, the luggage is air-permeable. In a similar manner, “hard-sided” luggage, while nominally presenting a hard plastic exterior, can be subject to an external force sufficient to momentarily depress or displace a side panel to reduce the interior volume thereof to express a portion of the interior air volume therefrom.

An air discharge plenum or hood 18 is positioned above the rollers 12 and is designed to discharge a flow of pressurized air in the direction of and onto the rollers 12 and any luggage articles L or packages being transferred on the rollers 12 from the conveyor 14 to the conveyor 16. The flow of pressurized air can take the form of a uniform flow, periodic or non-periodic pulses or bursts of air, or an air “curtain” or “shower” that sweeps across the conveyed luggage articles L in a recurring manner.

As explained below, the pressurized air flow will subject the luggage articles L and, especially any soft-sided luggage article, to a compressive force generally sufficient to compress the luggage article L somewhat to at least momentarily reduce its interior volume to express interior air therefrom. Any air-entrainable particulates or atoms, molecules, or vapors within the interior of the luggage article L, including those related to explosives, hazardous chemicals, and/or biohazards, will be expelled into the surrounding ambient air flow. Any materials expressed from the luggage article L will be entrained within and become part of the pressurized air flow supplied by the air discharge hood 18.

Where pulses or bursts of air are used, the pulse or burst pressure can be sufficiently high to at least partially penetrate the side-wall of any air-permeable luggage articles L to further increase the probability of expressing or aspirating a portion of the interior volume for test purposes.

The various rollers 12 are sized and spaced to force the various luggage articles L or packages to be lifted upward and then dropped or lowered downward onto the next roller 12 so that each luggage article L or package is subjected up and down elevational movements to kinetically to change the alignment and attitude of the luggage article L or package (as shown in dotted-line illustration in FIG. 1) as it is conveyed by the various rollers 12. The up and down “bumpy or jouncing ride” increases the probability that the contents of each luggage article L or package will be shifted or displaced to expel a portion of the interior air volume therefrom.

A suction inlet 20 is located below and adjacent the rollers 12 and functions to capture at least a portion of the pressurized air flow and any materials expressed from the luggage article L or package. The suction inlet 20 connects directly to a sensing suite 22 which, in turn, connects through an outlet duct 24 to a filter, adsorber, or scrubber 26 that removes any biohazard material(s) prior to exhausting the air into the ambient surroundings. An air mover 28, for example, an axial or radial flow fan, is located in the outlet duct 24 and has sufficient air moving capability to draw the air in the inlet of the air intake hood 20 into the biohazard sensing suite 22. The sensor suite 22 (typically including a plurality of diverse sensors) is designed to accept the air drawn into the suction hood 20 for analysis. The sensors can take the form, for example, of an ion mobility spectrometer-base sensor like the Barringer Technologies Ionscan 400B, for detecting explosives, chemical warfare agents, and illicit drugs, the Joint Biological Point Detection System (JBPDS) manufactured by Intellitec of Jacksonville, Fla., for detecting a plurality of biological pathogens. It is contemplated that the sensor suite will be suitable to detect air-entrainable particles, including explosives particles, particles of illicit drugs, radioactive particles, and vapors thereof as well as bacteria, bacterial spores, viruses, rickettsia, toxins, low-volatility chemical particles including chemical warfare agent particles like VX, and others.

As can be appreciated, the relative positions of the air discharge hood 18 and the suction inlet 20 (and related components) can be reversed so that the pressurized air flow will be directed upwardly from the air discharge hood 18 through and between the various the various rollers 12 to the suction inlet 20.

In operation, a flow or stream of luggage articles L and/or packages are transported along conveyor 14 and deposited onto the leftmost roller 12 for movement along the series of rollers 12 until being deposited onto the conveyor 16. The diameter and spacing or the various rollers 12 is designed to subject each luggage article L or package to successive kinetic movements designed to maximize the probability of expressing a portion of the interior volume therefrom. More particularly, the rollers 12 impart various kinetic movements, including successive up and down movements, to each luggage article L or package, these movements intended to generate or create the “bellows” effect and/or the “piston” effect. For any luggage article L that can be characterized as “soft-sided,” the bumping, jouncing, or agitating movement of that type of luggage along the rollers 12 will cause momentary compressive forces (with a consequent reduction in interior air volume) to be applied to the luggage article L or package to express a portion of the interior air. Additionally, the kinetic movement will, to some extent or the other, cause a position-shifting or displacement of the interior contents of each luggage article L or package of both the “soft-side” and “hard-side” type; the shifted or displaced contents functioning in a piston-like manner to displace at least a portion or the interior air into the exterior pressurized air flow.

The effect induced by the kinetic forces or movements as the luggage article L or package moves over the rollers 12 is cumulative to that caused by the pressurized air flow from the air discharge hood 18.

As shown in FIG. 1, a representative luggage article L or package is dropped from the conveyor 14 onto the leftmost roller 14 and consecutively lifted and lowered over the various rollers 12 until dropped onto the conveyor 16. Each lifting and dropping motion, including changes in alignment relative to the vertical, imparts a motion or motions that promotes both the “bellow” and the “piston” effect.

In general, it is preferred that a spacing exist between the rollers 12 to allow passage of the pressurized air flow from the air discharge hood 18 into the suction inlet 20. If preferred, the surface of each roller 12 can be fabricated from an air permeable material, such as an open-weave chain-mail, a screen-like material, or similar structure including a plurality of air holes in the surface of each roller 12. Where the rollers 12 are fabricated as an air-permeable structure, the rollers 12 can be closely spaced and/or in surface-to-surface contact with each other.

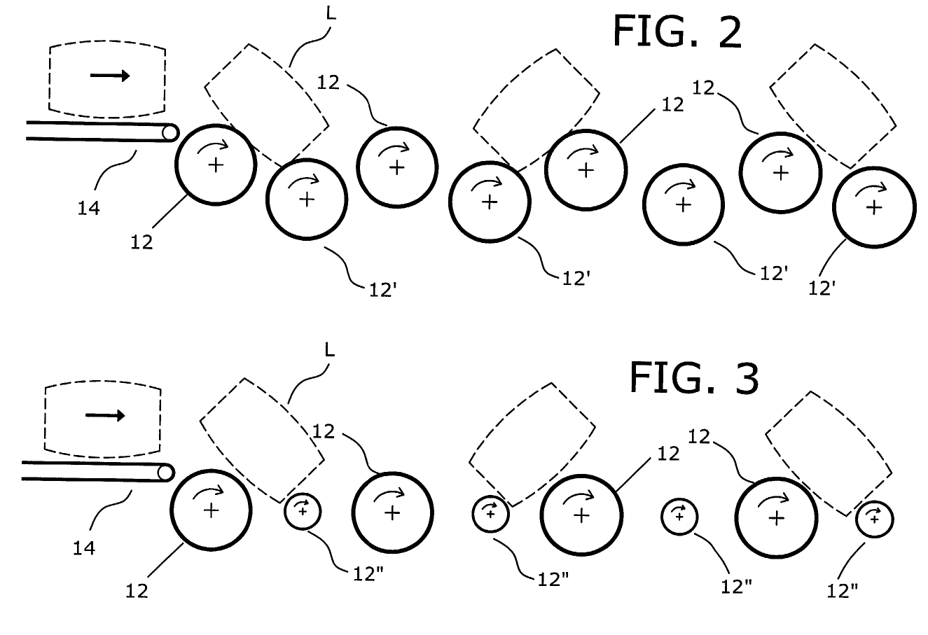

In FIG. 1, the various rollers 12 are shown as equi-spaced along a common plane and of equal diameter. As can be appreciated and as shown in FIGS. 1a and 1b and in FIGS. 2-6, a number of variants are suitable.

In FIG. 1, the various rollers 12 are shown equi-spaced along a common plane and of equal diameter. As shown in FIG. 1a, the various rollers 12 can be aligned along an arc that attains its maximum altitude at the center. As the luggage article L or package is lifted and lowered over each roller 12, it is also lifted to the crest of the arc and lifted and lowered on the downside or declining side of the arc, i.e., any luggage article or package being transported will also ascend and then descend relative to the horizontal as well as being lifted and lowered by the individual rollers 12. The downside or declining side of the arc, depending upon the rate of decline or declination, increases the agitating effect of the rollers 12. As shown in dotted line on the right side of FIG. 1a, one or more of the rollers 12 can be displaced up or down relative to its adjacent rollers 12 to increase the agitation effect and, if desired, one or more rollers 12 can have a non-circular cross-section (i.e., elliptical) in contrast to the circular cross-sections shown. An elliptical cross-section, depending upon the ratio of the major and minor axes, can cause a roller to have a ‘paddle’ effect on the luggage article or package being transported.

As shown in FIG. 1b, the rollers 12 can also be aligned with a inclined plane toward an apex at the center to allow the luggage article L or package to tumble onto the downside set of rollers 12. In FIG. 1b, one of the downside rollers 12 is shown as somewhat below the relative elevation or position of its adjacent rollers 12 to promote tumbling.

In FIG. 2, successive alternate rollers 12 are shown aligned in a first plane while the intermediate rollers 12′ are shown aligned in another plane spaced from the first plane. As can be appreciated, the staggered rollers 12 and 12′ provide for increased kinetic agitation over that of the organization of FIG. 1.

In FIG. 3, the successive alternate rollers 12 and the intermediate rollers 12″ are shown with two different diameters, the staggered-diameter rollers 12 and 12″ also providing for increased kinetic agitation over that of the organization of FIG. 1.

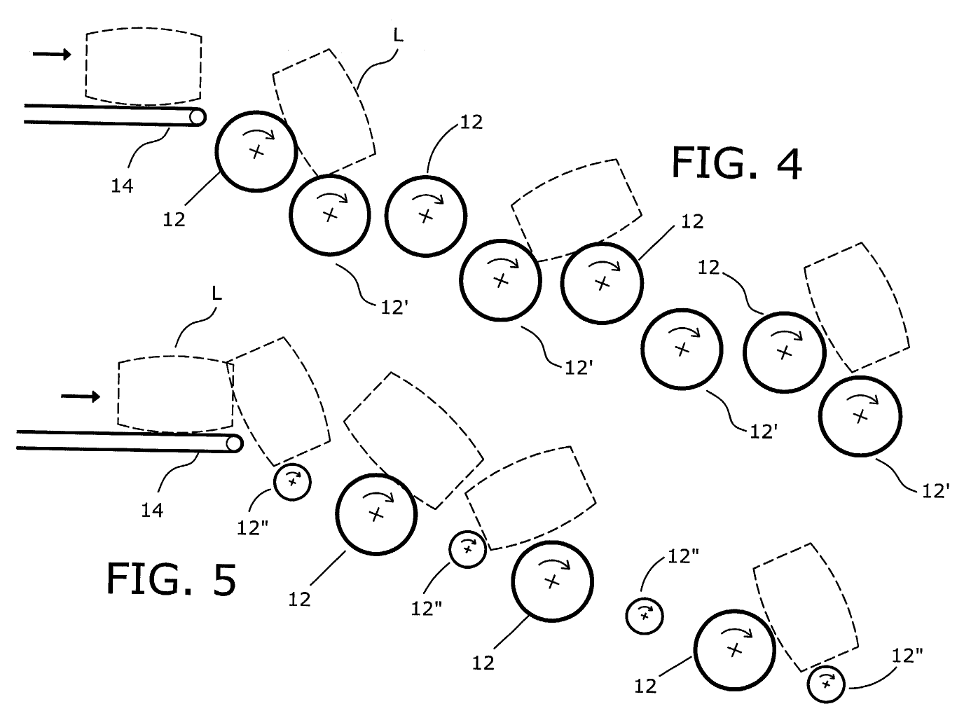

The organization of FIGS. 4 and 5 is similar to that of FIGS. 2 and 3; however, in FIGS. 4 and 5, the various rollers 12 and 12′ or 12″ are inclined at an angle relative to the horizontal so that gravity aids in the agitated or bumped kinetic movements of the luggage articles L or packages. In FIGS. 4 and 5, the declination angle is shown as 20 degrees; however, greater or lesser angles or declination are contemplated as within the scope of the invention. If desired, a measure of end-over-end tumbling of the luggage articles L or packages can be accomplished with larger declination angles.

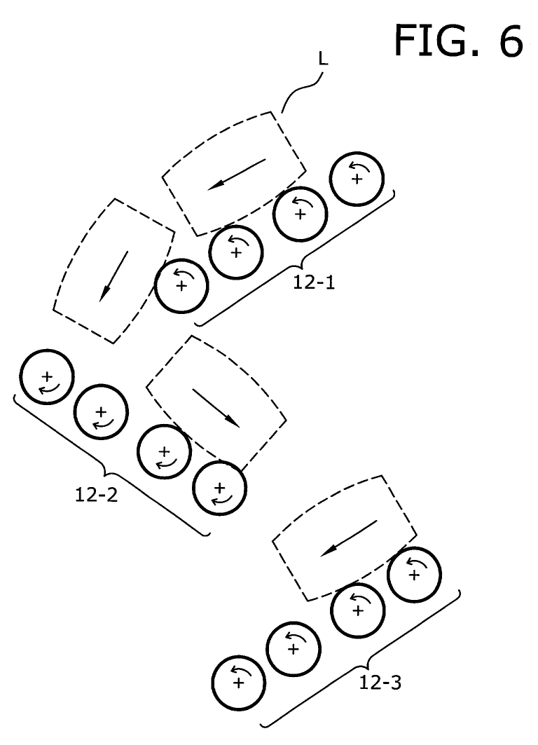

FIG. 6 shows a further variation of the present invention in which the rollers 12 are organized into roller sets 12-1, 12-2, and 12-3. The rollers sets 12-1, 12-2, and 12-3 are each aligned at an angle of declination and vertically spaced and staggered so that a luggage article L or package will be kinetically agitated as it moves along each roller set and as it is transferred from one roller set to the other.

In the various figures, the rollers are shown as turning in same direction to convey the luggage articles L or packages from the conveyor 14 to the conveyor 16. As can be appreciated, one or more rollers can be unpowered and one or more of the rollers can be counter rotated relative to the others in those situations in which it may be desired to increase the probability that the luggage article L or package will ‘flip’ as it is transported across the rollers.

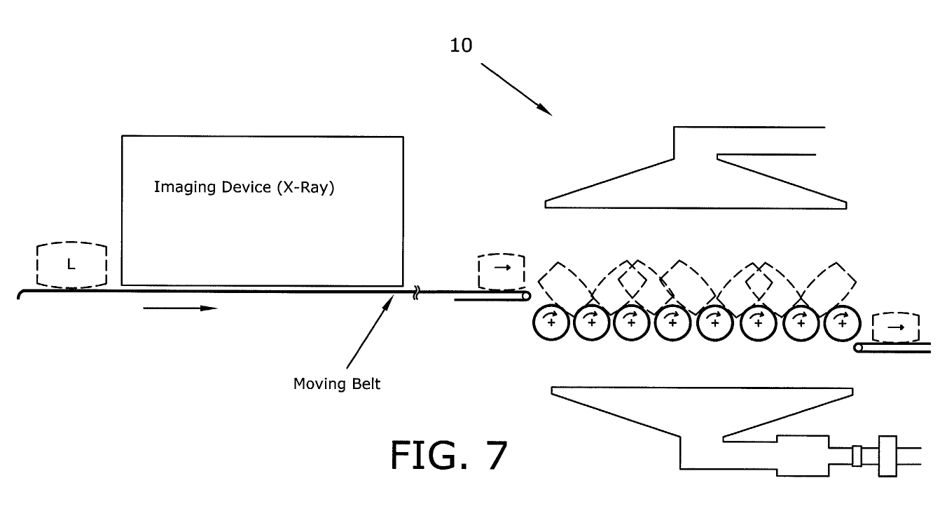

One or more of the above described embodiments or variants can be implemented in stand-alone applications or in parallel or in conjunction with other devices like conventional X-Ray imaging systems for detecting weapons, batteries, wiring or explosive detonators, etc. For example and as shown in FIG. 7, a conventional X-ray imager (unnumbered) is shown in a position in advance of the system 10 of the present invention. In operation, each luggage article L or package would is imaged in the imaging machine and then advanced into the system 10 of the present invention. As can be appreciated, these embodiments of the present invention and their variants optimally cooperate with imaging machines in current use or contemplated for future use.

As will be apparent to those skilled in the art, various changes and modifications may be made to the illustrated method and system for aspirating sample volumes from luggage/packages for test of the present invention without departing from the spirit and scope of the invention as determined in the appended claims and their legal equivalent.

What is claimed is:

1. A system for expressing a volume of air from the interior of a luggage article or package, comprising:
a plurality of rollers over which a luggage article or package is conveyed, the spacing, diameter, and alignment of the rollers imparting a kinetic movement to the luggage article or package sufficient to express air from the interior volume therefrom; and
means for subjecting the expressed air to an analysis for any undesired or proscribed materials.

2. The system of claim 1, further comprising:
means for directing pressured air toward luggage articles or packages conveyed and toward said analysis means.

3. The system of claim 1, wherein said plurality of rollers are spaced along a common plane, at least some of said rollers mechanically driven for rotation about a respective axis thereof, said rollers having a sufficient spacing therebetween to lift and lower a luggage article or package between at least a first and at least a second elevation relative said plane.

4. The system of claim 3, wherein said common plane is aligned along the horizontal.

5. The system of claim 3, wherein said common plane is aligned along a angle relative to the horizontal.

6. The system of claim 3, wherein each of said rollers is rotated by a driver in a common direction to transport a luggage article or package therealong.

7. The system of claim 3, wherein at least one of said rollers is undriven.

8. The system of claim 3, wherein at least one of said rollers is driven in a direction opposite from the other of said rollers.

9. The system of claim 3, wherein each roller is cylindrical.

10. The system of claim 3, where at least one roller is non-cylindrical.

11. The system of claim 1, wherein said plurality of rollers are spaced along a plane that rises and declines relative to the horizontal, at least some of said rollers mechanically driven for rotation about an axis thereof, said rollers a having sufficient spacing therebetween to lift and lower a luggage article or package between at least and a first and at least a second elevation relative to said plane.

12. The system of claim 11, wherein each of said rollers is rotated by a driver in a common direction to transport a luggage article or package therealong.

13. The system of claim 11, wherein at least one of said rollers is undriven.

14. The system of claim 11, wherein at least one of said rollers is driven in a direction opposite from the other of said rollers.

15. The system of claim 11, wherein each roller is cylindrical.

16. The system of claim 11, at least one roller is non-cylindrical.

17. The system of claim 1, wherein said plurality of first-mentioned rollers are spaced along a first common plane and further comprising a plurality of second rollers spaced along a second common plane spaced from said first common plane, at least some of said first-mentioned and second-mentioned rollers mechanically driven for rotation about an axis thereof, said rollers a having sufficient spacing therebetween to lift and lower a luggage article or package between at least a first elevation and at least a second elevation relative said first and second planes.

18. The system of claim 17, wherein said first rollers and second rollers are cylindrical in cross-section and at least a one of said first-mentioned rollers and said second-mentioned rollers are of a different diameter.

19. The system of claim 18, said first and second common plane are aligned at an angle relative to the horizontal.

20. A method of testing luggage articles and/or packages for undesired or proscribed materials, comprising the steps of:
transporting a luggage article or package along a plurality of rollers having spacing, diameter, and alignment to impart a kinetic movement to the luggage article or package sufficient to express air from the interior volume therefrom; and
subjecting the expressed air to an analysis for any undesired or proscribed materials.

21. The method of claim 20, further comprising:
subjecting the luggage article or package to a imaging system to image the contents thereof.
